(19) United States
(12) Patent Application Publication
(10) Pub. No.: US 2015/0321591 A1
(43) Pub. Date: Nov. 12, 2015

(54) METHOD FOR PRODUCING A SEAT BACKREST STRUCTURE OF A VEHICLE SEAT

(71) Applicant: GM GLOBAL TECHNOLOGY OPERATIONS LLC, Detroit, MI (US)

(72) Inventors: Christian KUHLEY, Gross-Gerau (DE); Jürgen MAIER, Weitersweiler (DE)

(73) Assignee: GM GLOBAL TECHNOLOGY OPERATIONS LLC, Detroit, MI (US)

(21) Appl. No.: 14/707,625

(22) Filed: May 8, 2015

(30) Foreign Application Priority Data
May 9, 2014 (DE) 102014006886.2

(51) Int. Cl. B60N 2/68; B29C 45/14; B60N 2/64

(52) U.S. Cl. CPC B60N 2/68; B60N 2/643; B29C 45/14467; B29K 2101/12

(57) ABSTRACT

A method is disclosed for producing a frame-like seat backrest structure of a vehicle seat. The seat backrest structure includes lateral members of metal and transverse members of plastic connected to these. In accordance with the method, the prefabricated lateral members are inserted in an injection mold and plastic is injected in the injection mold such that the transverse members are molded and connected to the lateral members.

### CROSS-REFERENCE TO RELATED APPLICATION

This application claims priority to German Patent Application No. 102014006886.2, filed May 9, 2014, which is incorporated herein by reference in its entirety.

### TECHNICAL FIELD

The present disclosure pertains to a method for producing a frame-like seat backrest structure of a vehicle seat. Such a seat backrest structure is mounted in the lower region in a seat lower part of the vehicle seat. The seat backrest of the vehicle seat includes the seat backrest structure and upholstery assigned to the same.

### BACKGROUND

DE 2010 007 052 A1 discloses a seat backrest or backrest of a vehicle seat with a frame-like basic structure formed of beams of a dimensionally stable plastic and a function element provided between the beams. The function element can be formed of plastic and/or as a plastic-coated insert. The production of the frame-like basic structure is preferably carried out in an injection mold by injection molding in one operation. The function elements with or without previously inserted inserts are injection molded or over-molded with plastic. The inserts can be stiffening elements produced in advance from metal or light metal which are embedded laterally visible or not visible in the basic structure of the backrest consisting of plastic.

### SUMMARY

The present disclosure provides a method for producing a frame-like seat backrest structure of a vehicle seat which, with great freedom of design, makes possible forming a seat backrest structure that is reduced in weight while reducing the number of required initial components of the seat backrest structure. The method for producing the frame-like seat backrest structure of a vehicle seat is based on the seat backrest structure including lateral parts or members of metal and transverse parts or members of plastic connected to the former.

For producing the frame-like seat backrest structure, the prefabricated lateral members are initially inserted in an injection mold. Following this, plastic is injected into the injection mold forming the transverse members and connecting the transverse members to the lateral members. By means of the method, a frame-like seat backrest structure of a vehicle seat is thus produced which consists of both metal and also plastic. Because of this, a seat backrest structure can be produced which has a relatively low weight with high stiffness. In particular, the production of the seat backrest structure takes place in such a manner that the transverse members in the region of the ends of the respective lateral member facing away are connected to the same.

It is provided, in particular, that the frame formed by the seat backrest structure, has a quadrangular shape, in particular approximately rectangular or trapezium shape. When formed as a trapezium, the seat backrest structure tapers towards the upper end, which is assigned to a head region of a vehicle occupant. Towards the lower region, there where the seat backrest structure is mounted in a seat lower part of the vehicle seat, the seat backrest structure widens.

It is considered to be particularly advantageous when the lateral members, prior to connecting to the transverse members, are pretreated or pre-worked at the connecting points with the transverse members. The pretreatment is carried out in particular in that the surfaces of the lateral members are modified by plasma technology at the connecting points with the transverse members. Through this plasma treatment process, the surface characteristics of the lateral members can be specifically changed in order to achieve a close connection between the lateral members and the transverse members. This pretreatment or surface activation of the lateral members requires in particular a modification of the lateral members in the micro-range. Through this treatment, the surface of the lateral members is also cleaned in the treated region, in particular freed of grease and dust.

Pre-working of the lateral members at the connecting points with the transverse members is carried out in particular in such a manner that the surfaces of the lateral members at the connecting points with the transverse members are provided with depressions or holes. In particular, the surfaces of the lateral members at the connecting points with the transverse members are provided with depressions or holes that are stepped in depth. This pre-working must be seen under a macroscopic aspect, following which injected plastic can flow into these depressions or holes and a positively joined connection between the lateral members and the transverse members is thus created.

Under the aspect of high stiffness of the seat backrest structure, in particular in the region of the transverse members, it is considered to be particularly advantageous when during the injecting of plastic transverse members including honeycomb structure are formed. This honeycomb structure is formed at least in a part region, preferentially in the region between the lateral members. In particular, lateral members consisting of steel are inserted in the injection mold. Furthermore, in particular glass fiber-reinforced plastic is injected into the injection mold.

The present disclosure and its further developments thus describe a production method of a frame-like seat backrest structure with transverse members of plastic, which are connected to lateral members of metal, in particular steel. The prefabricated metallic lateral members are inserted in an injection mold. In this injection mold, the lateral members are over-molded with plastic or plastic-covered during the production of the transverse members so that a connection between the lateral members and the transverse members is created. Accordingly, the production process combines the production of the transverse members and their connection to the lateral members of metal or steel in a production process or in a mold. Prior to the over-molding or plastic-covering of the lateral members, these are pretreated in the connecting region with the lateral members in order to ensure a secure connection between the lateral members and the transverse members. This pretreatment or surface activation is carried out in particular by means of a plasma treatment process.

### BRIEF DESCRIPTION OF THE FIGURES

The present disclosure will hereinafter be described in conjunction with the following drawing figures, wherein like numerals denote like elements.

FIG. 1 is a three dimensional representation of a seat backrest structure of a vehicle seat produced according to the method according to the present disclosure, seen from the direction of a lower part of the vehicle seat that is not shown;

FIG. 2 the seat backrest structure according to FIG. 1 in an exploded representation;

FIG. 3 a three dimensional view of an upper end of a lateral member of the seat backrest structure; and

FIG. 4 a detail of this upper end of the seat backrest structure, illustrated in a section through the lateral member in the region of a hole introduced into the same.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

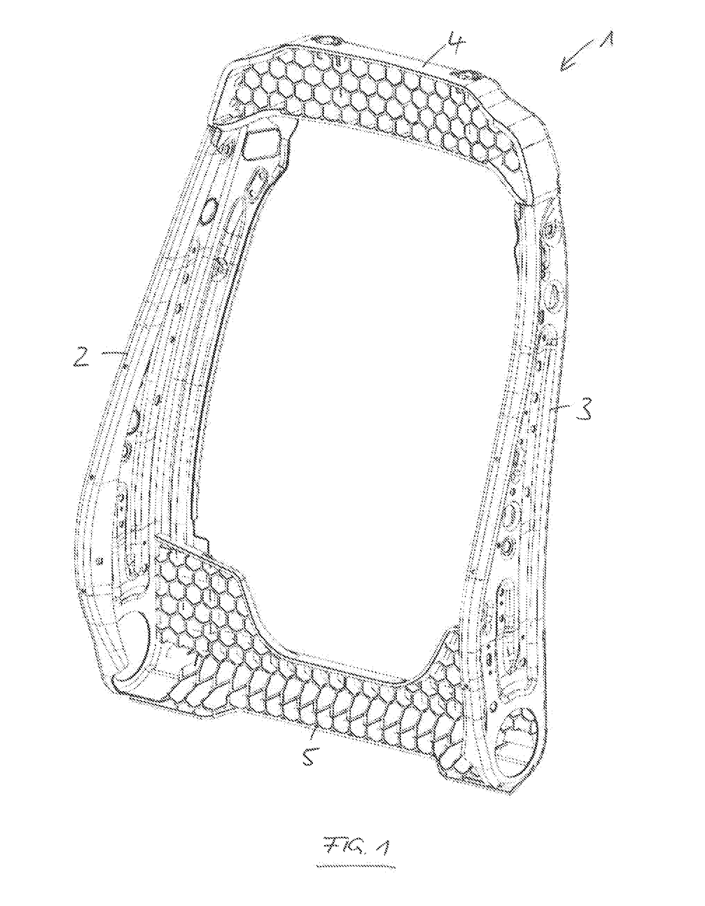

FIG. 1 shows the frame-like seat backrest structure 1 of a vehicle seat produced according to the method according to the present disclosure. To better illustrate the individual components of the seat backrest structure 1, these are shown in an exploded representation in FIG. 2. The seat backrest structure 1 includes two lateral parts or members 2 and 3 of a shaped steel plate and transverse parts or members 4, 5 of glass fiber-reinforced plastic connected to the two lateral members 2 and 3. The transverse members 4 and 5 have a honeycomb structure. The transverse member 4 connects the two lateral members 2 and 3 in the region of the upper ends of the lateral members 2, 3. The transverse member 5 connects the two lateral members 2 and 3 in the region of the lower ends of the lateral members 2, 3. The lateral members 2, 3 are formed mirror-symmetrically.

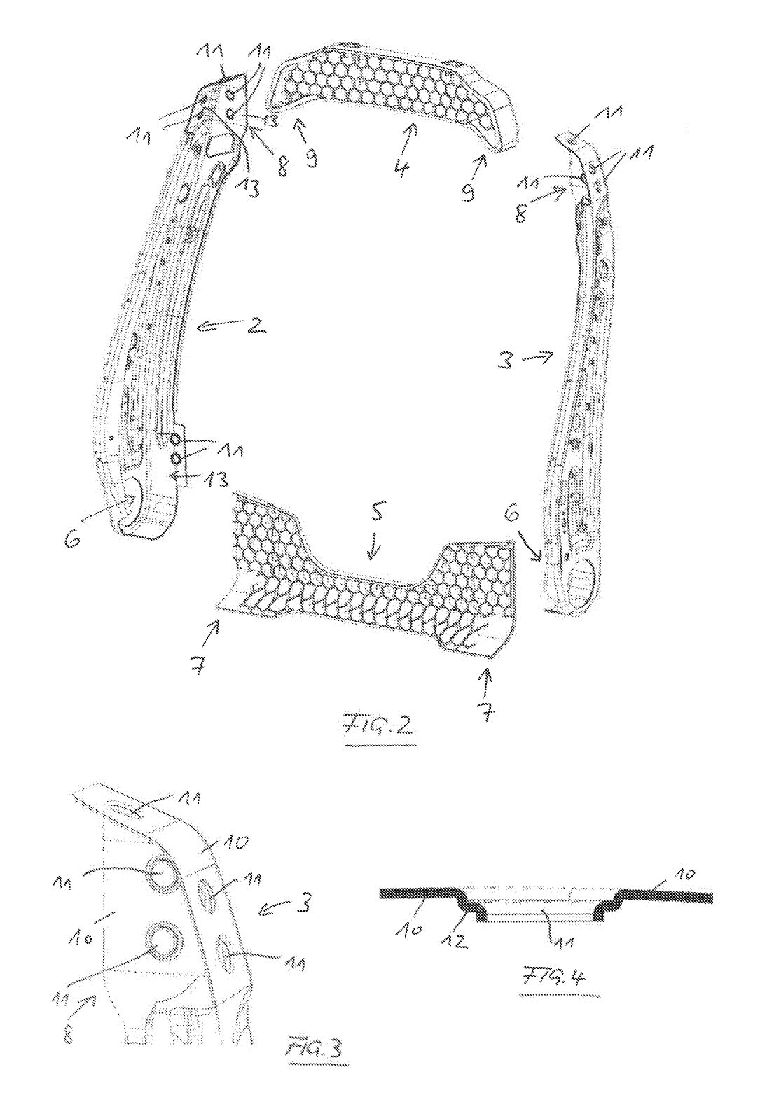

The respective lateral member 2 and 3 includes a shell-like mounting 6 at the bottom for receiving a facing end 7 of the transverse member 5 which is formed approximately L-shaped in cross section. In the region of the upper end, the respective lateral member 2 or 3 has a shell-like mounting 8 for receiving the end 9 of the transverse member 4 facing the lateral member 2 and 3 respectively. The transverse member 4 is formed strip-shaped. The lateral member 2 and 3 formed of steel plate includes holes 11 penetrating the plate 10 in the region of the mountings 6 and 8, the holes 11 being stepped in depth. The respective step is marked with the reference number 12. The arrangement of the holes 11 for the shell-like mounting 8 of the lateral member 3 is illustrated in detail in FIG. 3.

With respect to the method for producing the seat backrest structure 1 illustrated in FIG. 1, the prefabricated lateral members 2 and 3 are used as a base. In the region of the shell-like mountings 6 and 8, in particular of the part surfaces 13, where these are only numbered with respect to the lateral member 2, these are pretreated in a plasma treatment process. Following this, the two lateral members 2, 3 are inserted in an injection mold. This is followed by the injection of the plastic, consequently the glass fiber-reinforced plastic into the injection mold with forming of the transverse members 4, 5 and connecting of the transverse members 4, 5 to the lateral members 2, 3. Because of the plasma pretreatment, a fixed connection of the lateral members 2, 3 and transverse members 4, 5 in the region of the mountings 6, 8 of the lateral members 2, 3 are obtained. Furthermore, a positively joined connection is effected in the region of the holes 11, which the plastic penetrates. During the injecting of the plastic, the transverse members 4, 5 including the honeycomb structure are molded.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-9. (canceled)

10. A method for producing a frame-like seat backrest structure of a vehicle seat comprising:
positioning first and second lateral members in an injection mold; and
injecting plastic in the injection mold to form first and second transverse members connecting the first and second lateral members.

11. The method according to claim 10, wherein the first transverse member connects the first and second lateral members in a first region proximate a first end thereof and the second transverse member connects the first and second lateral members in a second region proximate a second end thereof.

12. The method according to claim 11 further comprising pretreating or pre-working to modify the first and second region at a connecting point with the first and second transverse members.

13. The method according to claim 12, further comprising modifying a surface of the lateral members at the connecting points using a plasma technique.

14. The method according to claim 12, further comprising forming a hole in the surface of the lateral parts at the connecting points.

15. The method according to claim 12, further comprising forming a depression hole in the surface of the lateral parts at the connecting points.

16. The method according to claim 15, wherein the depression formed in the surface of the lateral parts is stepped in depth.

17. The method according to claim 10, further comprising injecting plastic in the injection mold to mold first and second transverse members having a honeycomb structure.

18. The method according to claim 10, wherein the first and second lateral members are metal members.

19. The method according to any one of the claims 18, wherein the first and second lateral parts comprise steel parts.

20. The method according to any one of the claims 10, wherein the plastic injected into the mold comprises a glass fiber-reinforced plastic.
